(19) United States
(12) Patent Application Publication
(10) Pub. No.: US 2006/0190702 A1
(43) Pub. Date: Aug. 24, 2006

(54) Device and method for correcting errors in a processor having two execution units

(76) Inventors: Werner Harter, Illingen (DE); Thomas Kottke, Ehningen (DE); Yorck Collani, Beilstein (DE); Andreas Steininger, Wien (AT); Christian El Salloum, Wien (AT)

Correspondence Address: KENYON & KENYON LLP, ONE BROADWAY, NEW YORK, NY, 10004, US

(21) Appl. No.: 11/293,385

(22) Filed: Dec. 2, 2005

(30) Foreign Application Priority Data
Dec. 2, 2004 (DE) 10 2004 058 288.2

(51) Int. Cl. G06F 15/00

(52) U.S. Cl. 712/15

(57) ABSTRACT

A method and a device for correcting errors in a processor having two execution units as well as a corresponding processor, in which registers are provided in which instructions and/or associated information can be stored, the instructions being processed redundantly in both execution units and comparison means being included, and being such that by comparing the instructions and/or the associated information a deviation and thus an error is detected, a division of the registers of the processor into first registers and second registers being provided, the first registers being such that a specifiable state of the processor and contents of the second registers are derivable from them, means for a rollback being included, which are such that at least one instruction and/or the information in the first registers are rolled back and are executed anew and/or restored.

### PRIORITY APPLICATION INFORMATION

The present application claims priority to German Patent Application No. 10 2004 058 288.2, which was filed in the German Patent Office on Dec. 2, 2004, and the entire contents of which is hereby incorporated by reference.

### FIELD OF THE INVENTION

The exemplary embodiment and/or exemplary method of the present invention relates to a device and a method for correcting errors in a processor having two execution units or two CPUs as well as a corresponding processor.

### BACKGROUND INFORMATION

Due to the fact that semiconductor structures are becoming smaller and smaller, an increase in transient processor errors is expected, which are caused e.g. by cosmic radiation. Even today transient errors are already occurring, which are caused by electromagnetic radiation or induction of interferences into the supply lines of the processors.

According to the related art, errors in a processor are detected by additional monitoring devices or by a redundant processor or by using a dual-core processor.

A dual-core processor or processor system is made up of two execution units, in particular two CPUs (master and checker), which are processing the same program in parallel. The two CPUs (central processing unit) may operate in a clock-synchronized manner, that is, in parallel (in a lockstep mode) or in a manner that is time-delayed by a few clock cycles. Both CPUs receive the same input data and process the same program, although the outputs of the dual core are driven exclusively by the master. In each clock cycle, the outputs of the master are compared to the outputs of the checker and are thus verified. If the output values of the two CPUs do not agree, then this means that at least one of the two CPUs is in a faulty state.

In an exemplary architecture for a dual core processor, a comparator for this purpose compares the outputs (instruction address, data out, control signals) of both cores (all comparisons occurring in parallel):

Instruction address (Without a check of the instruction address, the master could address the wrong instruction without this being noticed, which would then be processed in both processors without being detected.)

Data out

Control signals such as write enable or read enable

The error is signaled to the outside and normally results in a shutdown of the affected control unit. With the expected increase in transient errors, this sequence would result in a more frequent shutdown of control units. Since in the case of transient errors there is no damage to the processor, it would be helpful to make the processor available again to the application as quickly as possible without the system shutting down and a restart having to be performed.

Methods for correcting transient errors while avoiding a complete restart of the processor are rarely found for processors working in a master/checker operation.

The publication by Jiri Gaisler, “Concurrent error-detection and modular fault-tolerance in a 32-bit processing core for embedded space flight applications”, from the Twenty-Fourth International Symposium on Fault-Tolerant Computing, pages 128-130, June 1994, refer to a processor having integrated error detection and recovery mechanisms (e.g. parity checking and automatic instruction repetition), which is capable of working in master/checker operation. The internal error detection mechanisms in the master or in the checker always trigger a recovery operation only locally in one processor. As a result, the two processors lose their synchronicity with respect to each other and it is no longer possible to compare the outputs. The only option for synchronizing the two processors again is to restart both processors during a non-critical phase of the mission.

Furthermore, the document by Yuval Tamir and Marc Tremblay entitled, “High-performance fault-tolerant vlsi systems using micro rollback” in IEEE Transactions on Computers, volume 39, pages 548-554, 1990, refers to a method called “micro rollback”, by which the complete state of an arbitrary vlsi system can be rolled back by a certain number of clock cycles. For this purpose, all registers and the register file as a whole are extended by an additional FIFO buffer. According to this method, new values are not written directly into the register itself, but rather are first stored in the buffer and are transferred to the register only after having been checked. To roll back the entire processor state, the contents of all FIFO buffers are marked as invalid. If it is to be possible to roll back the system by up to k clock cycles, then k buffers are needed for each register.

The processors presented in the related art thus on the one hand have above all the defect that they lose their synchronicity as a result of the recovery operations since recovery is always performed only locally in one processor. The basic idea of the described method (micro rollback) is to extend each component of a system independently to include rollback capability so as to be able to roll back the entire system state in a consistent manner in the case of an error. The architecture-specific interconnection of the individual components (register, register file, . . . ) does not have to be considered for this purpose since indeed the entire system state is always rolled back consistently. The disadvantage of the method is a large hardware overhead, which grows in proportion to the size of the system (e.g. the number of pipeline stages in the processor).

### SUMMARY OF THE INVENTION

An objective of the exemplary embodiment and/or exemplary method of the present invention is that of correcting particularly transient errors without a system or processor restart while at the same time avoiding an excessively large expenditure, particularly of hardware.

This objective may be achieved by a method and a device for correcting errors in a processor having two execution units and the corresponding processor, registers being provided in which instructions and/or associated information can be stored, the instructions being processed redundantly in both execution units and comparison means such as for example a comparator being included, which are designed in such a way that by comparing the instructions and/or the associated information a deviation and thus an error is detected, a division of the registers of the processor into first registers and second registers being advantageously provided, the first registers being designed in such a way that a specifiable state of the processor and contents of the second registers are derivable from them, means for a rollback being included, which are designed in such a way that at least one instruction and/or the information in the first registers are rolled back and are executed anew and/or restored.

According to the exemplary embodiment and/or exemplary method of the present invention, only a part of the register contents of a processor is needed to be able to derive the entire processor state. The set of all registers of a processor is divided into two subsets:

“Essential registers”: The contents of these first registers are sufficient to be able to build up a consistent processor state.

“Derivable registers”: These second registers may be completely derived from the essential registers.

In this approach it is sufficient to protect only the essential registers against faulty values or to provide them with rollback capability in order to be able to roll the entire processor back to an earlier state in a consistent manner. Consequently, the means for rolling back are suitably assigned only to the first registers and/or are only contained in these, or the means for rolling back are designed in such a way that at least one instruction and/or the information is rolled back only in the first registers.

Thus, the comparison means are suitably also provided in front of the first registers and/or in front of the outputs.

For this purpose, at least one, in particular two buffer components are advantageously assigned to each first register, which also applies to the register files. That is to say, the registers are organized in at least one register file and at least one, in particular two buffer components having each one buffer memory for addresses and one buffer memory for data are assigned to this register file.

An arrangement, structure or apparatus is suitably included to specify and/or indicate a validity of the buffer component or buffer memory e.g. by a valid flag, the validity of the instructions and/or information being specifiable and/or ascertainable via a validity identifier (e.g. valid flag) and this validity identifier being reset either via a reset signal or via a gate signal, in particular of an AND gate.

According to the exemplary embodiment and/or exemplary method of the present invention, both approaches are provided, namely, that the two execution units and thus also the exemplary embodiment and/or exemplary method of the present invention work in parallel without clock cycle offset or with clock cycle offset.

To this end, at least all first registers suitably exist in duplicate and are in each case assigned once to an execution unit.

Advantageously, the rollback is divided into two phases, initially the first registers, that is, in particular the instructions and/or information of the first registers, being rolled back and then the contents of the second registers being derived from them. In the process, the contents of the second registers are suitably derived by a trap/exception mechanism.

In a specific embodiment for a further increase in security in addition to the rollback at least one bit flip, that is, bit dropout, of a first register of an execution unit is corrected in that the bit flip is indicated in both execution units. This has the advantage that it preserves the synchronicity of both execution units with or without clock cycle offset. For this purpose, the bit flip is simultaneously indicated in both execution units if the execution units are working without clock cycle offset, and the bit flip is indicated in an offset manner in both execution units in accordance with a specifiable clock cycle offset if the execution units are working with this clock cycle offset.

In this manner, the mechanism provided by us corrects a transient error within a few clock cycles.

Additional advantages and advantageous refinements are derived from the description and the features which are described herein.

### BRIEF DESCRIPTION OF THE DRAWINGS

FIG. 1 shows an exemplary dual-core processor system.

FIG. 2 shows the exemplary embodiment and/or exemplary method of the present invention with reference to a dual-core processor having a division of registers.

FIG. 3 shows the exemplary embodiment and/or exemplary method of the present invention with reference to a dual-core processor having a register division and rollback capability of the registers without clock cycle offset.

FIG. 4 shows an individual register according to the exemplary embodiment and/or exemplary method of the present invention having rollback capability and a buffer.

FIG. 5 shows a register file according to the exemplary embodiment and/or exemplary method of the present invention having rollback capability and separate buffers for address and data.

FIG. 6 shows a dual-core system for showing the bit flip correction in processors without clock cycle offset.

FIG. 7 shows a system for buffering the outputs according to the exemplary embodiment and/or exemplary method of the present invention.

FIG. 8 shows the exemplary embodiment and/or exemplary method of the present invention now with reference to a dual-core processor having a register division and rollback capability of the registers with clock cycle offset.

FIG. 9 shows an individual register according to the exemplary embodiment and/or exemplary method of the present invention having rollback capability and two buffers as well as a reset of the valid bits via AND gate.

FIG. 10 shows an individual register according to the exemplary embodiment and/or exemplary method of the present invention having rollback capability and two buffers as well as a reset of the valid bits via reset.

FIG. 11 shows a register file according to the exemplary embodiment and/or exemplary method of the present invention having rollback capability and two buffers as well as a reset of the valid bits via AND gate.

FIG. 12 shows a register file according to the exemplary embodiment and/or exemplary method of the present invention having rollback capability and two buffers as well as a reset of the valid bits via reset.

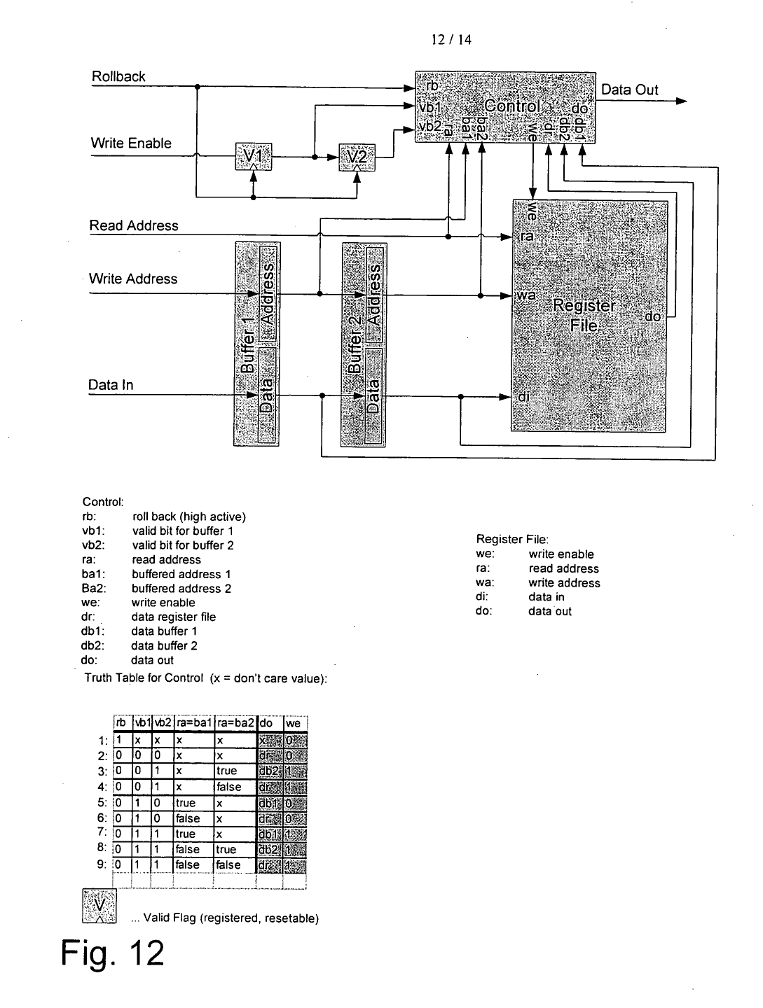

FIG. 13 shows a dual-core system for showing the bit flip correction in processors with clock cycle offset.

FIG. 14 shows the triggering of the trap RET for parity errors in the checker as an instruction diagram.

### DETAILED DESCRIPTION

Two embodiments or versions of the recovery mechanism are described herein. In the first version, “basic instruction retry mechanism” (BIRM), the essential registers are protected against having faulty data written to them (the data are checked before being written). Valid contents in the essential registers are sufficient to generate at any time a valid total processor state (the contents of the derivable registers being derivable from the essential registers).

For performance reasons, in the second version, “improved instruction retry mechanism” (IIRM), the essential registers are expanded to include rollback capability and allow for faulty values to be detected only when they have already been written to the essential registers (the error detection in this case working parallel with respect to the writing of the data). In the IIRM, the rollback occurs in two steps: First, all essential registers are rolled back to a valid state. In the second step, the derivable registers are filled with the derived values. The refilling of the derivable registers is accomplished in both versions by the trap/exception mechanism already present in most processors (requirements for the mechanism are described in chapter 4).

The exemplary embodiment and/or exemplary method of the present invention reduces the hardware overhead in comparison to known (micro-)rollback technologies on the basis of the following points:
The only registers that must be protected against faulty values or must be equipped with rollback capability (that is, with buffers) are the essential registers.
The number of the essential registers does not necessarily grow with the complexity (e.g. the number of pipelines stages) of the processor.
The trap mechanism already present in most processor architectures is used for deriving the register contents of the derivable registers and thus no additional hardware is required.

In contrast to the related art, the recovery operations in the architecture provided by us do not destroy the synchronicity between master and checker.

For this purpose, first a dual-core architecture working in lockstep mode, i.e. in a clock-synchronized manner, is described, which is capable of automatically correcting internal transient errors within a few clock cycles. In order to allow for a precise error diagnosis, internal comparators are additionally integrated into the dual core. A large part of the transient errors may be corrected by repeating instructions in which the error occurred. In the approach described, the trap/exception mechanism already present in conventional processors may be used for repeating instructions, thus producing no additional hardware overhead.

Errors arising from bit flips in the register file can generally not be corrected by the repetition of instructions. Such errors are reliable detected e.g. by parity and are reported to the operating system by a special trap. The error information provided is called precise, which means that the operating system is also told which instruction attempted to read the faulty register value. Thus the operating system is able to initiate an appropriate action for correcting the error. Examples of possible actions are, inter alia, calling a task-specific error handler, repeating the affected task or restarting the entire processor in the event that an error cannot be corrected (e.g. an error in the memory structures of the operating system).

The exemplary embodiment and/or exemplary method of the present invention thus provides a method, a device and a processor, which is able to detect transient errors reliably and to correct them within a few clock cycles. The processor is designed as a dual-core processor. It is made up of two CPUs (master and checker), both of which process the same program in parallel. Error detection is achieved by comparing various selected signals of the master and the checker. Transient errors are mainly corrected by instruction repetition. Bit flips in the register file are detected by parity checking and are reported to the operating system. As mentioned, the mechanism for instruction repetition is described in two variants: The first variant called “basic instruction retry mechanism” (BIRM) is designed to minimize hardware overhead, but may in some architectures also influence the performance of the processor negatively. The second variant called “improved instruction retry mechanism” (IIRM) entails less performance loss, but creates a greater hardware overhead instead.

On the one hand, dual-core processors are used for this purpose, which work in a lockstep mode. The term lockstep mode signifies in this context that both CPUs (master and checker) work in a clock-synchronized manner with respect to each other and process the same instruction at the same time. Although the lockstep mode represents an uncomplicated and cost-effective variant for implementing a dual-core processor, it also entails an increased susceptibility of the processor to common mode errors. Common mode errors are defined as errors that occur simultaneously in different subcomponents of a system, have the same effect and were caused by the same failure. Since in a dual-core processor both CPUs are accommodated in a common housing and are supplied by a common voltage source, certain failures (e.g. voltage fluctuations) may simultaneously affect both CPUs. Now if both CPUs are in exactly the same state, which is always the case in lockstep operation, then the probability that the failure affects both CPUs in exactly the same manner cannot be neglected. Such an error (common mode error) would not be detected by a comparator since both the master as well as the checker would provide the same incorrect result.

The exemplary embodiment and/or exemplary method of the present invention thus provides a processor, which is able to detect transient errors reliably and to correct them within a few clock cycles. The processor is designed as a dual-core processor. It is made up of two CPUs (master and checker), both of which process the same program in parallel. Error detection is achieved by comparing various selected signals of the master and the checker. In order to reduce the susceptibility to common mode errors, master and checker work at a clock cycle offset, which means that the checker always runs behind the master by a defined time interval (e.g. 1.5 clock cycles) (the two CPUs therefore being at no time in the same state). This has the consequence that the results of the master can only be checked by the comparator following this defined time lag since it is only then that the corresponding signals of the checker are provided. The results of the master can thus only be checked when the result of the checker are available and must be buffered, i.e. stored temporarily, in the meantime.

These two examples of the architecture having a clock cycle offset and having no clock cycle offset illustrate also the multifarious possible uses of the subject matter of our invention. In the following, both examples will be presented, there being no strict separation made with regard to the subject matter of the exemplary embodiment and/or exemplary method of the present invention and statements and representations presented with respect to it. Thus, according to the exemplary embodiment and/or exemplary method of the present invention, the examples corresponding to all 14 Figures can be combined arbitrarily.

If an error is detected, then quasi the entire dual core is rolled back to a state prior to the occurrence of the error, from which the program execution is resumed without having to perform a restart or a shutdown.

The following description with the figures shows, among other things, how a recovery mechanism may be integrated into a dual-core processor. In this instance, the architecture used serves as an exemplary architecture (the use of the recovery mechanism according to the exemplary embodiment and/or exemplary method of the present invention being not bound e.g. to a three-stage pipeline). The only requirement placed on the processor architecture is that it is a pipeline architecture, which has a mechanism, in particular an exception/trap mechanism that satisfies the requirements. The control signals (e.g. write enable, read enable etc.) that lead to the I/O are in all figures generally designated as control.

Instruction Repetition

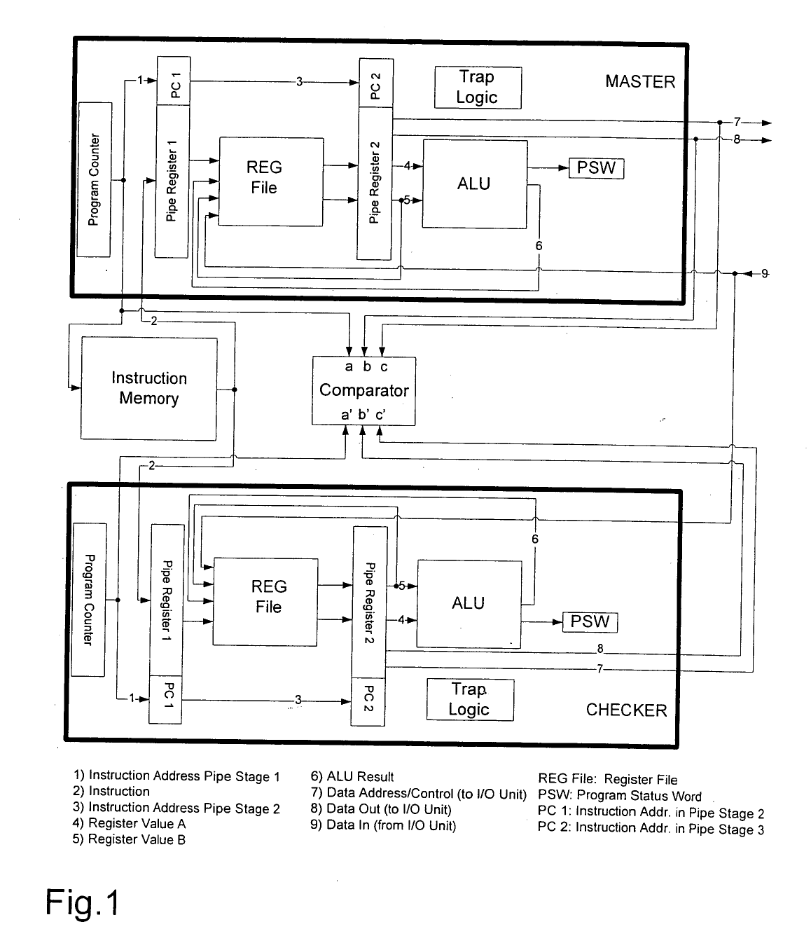

In FIG. 1, in an exemplary architecture for a dual core processor, a comparator for this purpose compares the outputs (instruction address, data out, control signals) of both cores (all comparisons occurring in parallel):
a) instruction address (Without a check of the instruction address, the master could address the wrong instruction without this being noticed, which would then be processed in both processors without being detected.)
b) data out
c) control signals such as write enable or read enable

The error is signaled to the outside and in this case now does not result in a shutdown of the affected control unit. Since in the case of transient errors there is no damage to the processor the processor is now made available again to the application as quickly as possible without the system shutting down and a restart having to be performed.

The recovery mechanism according to the exemplary embodiment and/or exemplary method of the present invention is based on error detection and instruction repetition. If an error is detected in any arbitrary pipeline stage, then the instruction in the last pipeline stage is always repeated. The repetition of an instruction in the last pipeline stage has the consequence that all other instructions in the front pipeline stages (the subsequent instructions) are also repeated, as a result of which the entire pipeline is again filled with new values. In this case, the instruction repetition is carried out by the trap (exception) mechanism already present in most conventional processors.

The trap (exception) mechanism for this purpose must satisfy the following requirements: As soon as a trap is triggered, any instruction present in the pipeline of the processor at this time will be prevented from changing the processor state. External write accesses (e.g. to the data memory, to additional modules such as network interfaces or DIA converters, . . . ) are likewise prevented. In the subsequent clock cycle, the system jumps into a trap routine assigned to the trap. A trap routine may be terminated again by the instruction “return from trap routine”, which results in the execution being resumed again with the instruction that was present in the last pipeline stage at the time the trap was triggered.

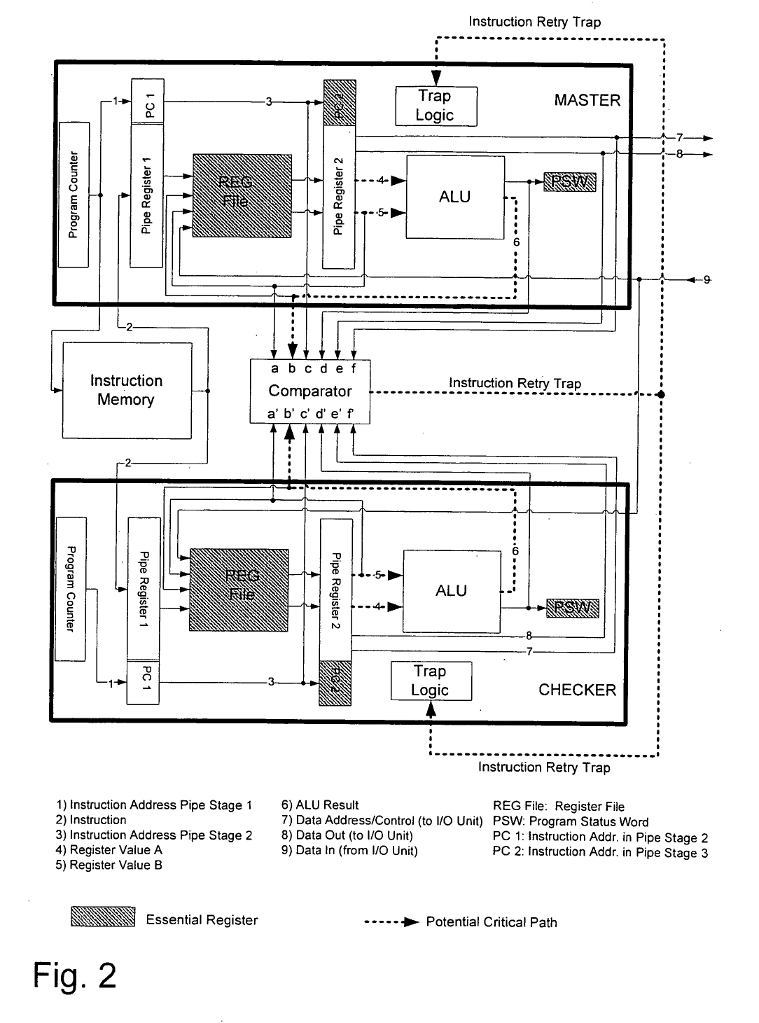

Now, in order to repeat an instruction with the aid of the trap mechanism, an “empty” trap routine is called (an empty trap routine is defined as a routine made up exclusively of the instruction “return from trap routine”). Since it is an “empty” trap routine, it is again terminated immediately after being called. The pipeline is emptied and the execution is resumed again precisely with the instruction that was present in the last pipeline stage at the time the trap was triggered. This empty trap routine is called an instruction retry trap. The instruction retry trap can bring about a valid processor state only if certain registers have a valid and consistent content. The set of these registers is called essential registers and includes all registers the contents of which determine the processor state following a trap call. This includes above all the register file, the status register and, depending on the architecture, various control registers such as an exception vector table for example. The most important register of the essential registers is the register that stores the address of the instruction in the last pipeline stage since it is precisely this address to which the system must jump when terminating the trap. In FIG. 2, the essential registers are shown in an exemplary architecture (REG file: register file, PC 2: address of the instruction in the last pipe stage, PSW: status register).

Any faulty value that is written into the essential registers must be reliably detected as faulty. In the first version of the instruction retry mechanism (BIRM), all values that are written to the essential registers are checked before they are actually taken over into the registers. The values are checked by a comparator which compares the signals of the master with those of the checker in each clock cycle (FIG. 2). In FIG. 2, the comparator in each case compares signal a with a′, b with b′, c with c′, . . . (the comparisons occurring in parallel). If at least one pair of associated signals do not match, then the comparator already triggers the instruction retry trap in the same clock cycle. This has the result that the faulty values are not written to the essential registers and that the faulty instruction is repeated.

The diagram in Table 1 shows the function of the basic instruction retry mechanism (BIRM) with the aid of an example. The diagram shows (under Instructions) in which pipeline stage a particular instruction is found during a particular clock cycle.

TABLE 1
Exemplary Sequence of the BIRM

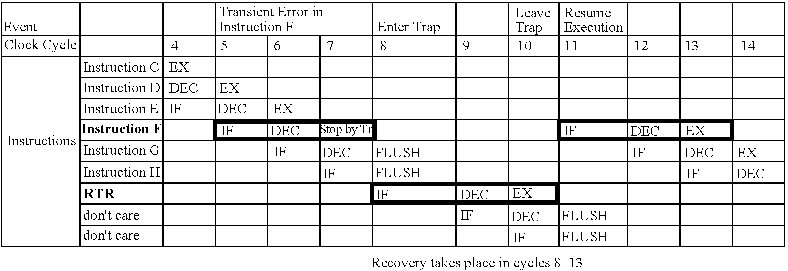

Legend:
IF Instruction Fetch
DEC Decode
EX Execute
RTR Return from Trap Routine
Stop by Tr (Trap) If a synchronous trap is activated no new values are written to registers/buffers

It is assumed that a transient error occurs at any stage of the instruction F (cycle 5-7). In clock cycle 7 at the latest, this error is detected by the comparator, instruction F is prevented from writing its results, and the InstructionRetryTrap is triggered. The InstructionRetryTrap is an empty trap and is thus only made up of the “return from trap routine” (RTR) instruction. In cycle 10, the RTR instruction has already reached the execute stage, which results in a renewed fetching of the previously faulty instruction F in clock cycle 11. At the beginning of clock cycle 14, the instruction F was repeated entirely and it wrote its correct results.

The disadvantage of the basic IRM (BIRM) is that the comparator in many architectures will lie in the time-critical path since the new values can only be taken over into a register if they have already been compared. The computation of new data by the ALU, the comparison of the data of the master and the checker and the triggering of the trap mechanism must thus all occur in the same clock cycle (the potentially critical path is shown in FIG. 2).

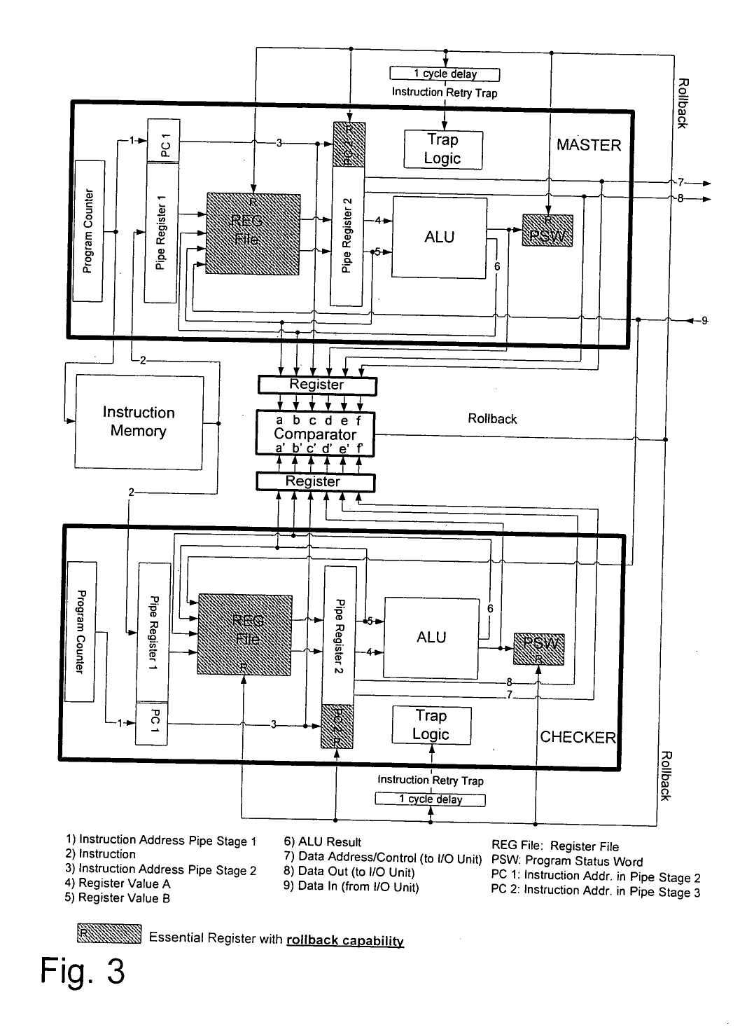

In the second version of the instruction retry mechanism (IIRM), the following strategy was chosen in order to shorten the time-critical path (FIG. 3). The signals to be compared are first stored temporarily in a register and are only compared in the subsequent clock cycle. Thus in the case of the IIRM, the critical path of the BIRM is divided into two shorter parts. Therefore, a whole clock cycle is available for comparing the signals between master and checker and for triggering the trap since the comparator and the CPUs are now able to work in parallel. Of course, with this method an error is detected only when faulty values have already been taken over into the registers. To meet this problem, the essential registers in the IIRM are equipped with rollback capability. If an error is detected, then the registers are first rolled back to a valid state (one clock cycle) and subsequently the instruction retry trap is triggered (FIG. 3). The “1-cycle delay” component delays the triggering of the instruction retry trap by one clock cycle and thus ensures that the instruction retry trap is only triggered when the essential registers have already been rolled back.

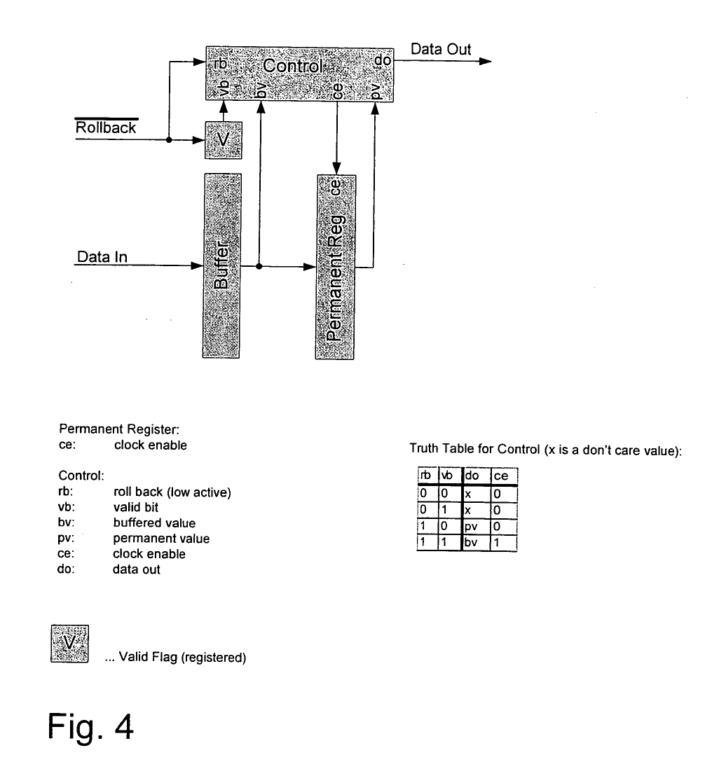

FIG. 4 shows how a single register can be equipped with rollback capability (registers PC 2 and PSW in FIG. 3 being rollback-capable registers). A rollback-capable register is made up of a permanent register, a buffer, a valid bit and a control logic. New data are not written directly into the permanent register, but are first stored in a buffer. If at the time of storing the data the rollback signal is inactive (rb=1; rb is low-active), then the buffer content is marked as valid using a valid bit (vb=1). If at the beginning of the following clock cycle the rollback signal is still inactive (that is, no rollback is to occur), then the content of the buffer is transferred to the permanent register (ce=1; if clock enable is active, the register takes over the applied value with the next clock cycle edge). On the other hand, if the rollback signal is active (rb=0; rollback is to occur), then the permanent register keeps its old value (ce=0; if clock enable is inactive, the register keeps its current value), and the buffer content is marked as invalid using the valid bit (vb=0). A buffer content marked as invalid (vb=0) is never taken over into the permanent register. In a read access, the buffer content (do=bv) is returned in the case of a buffer marked as valid (vb=1), while the content of the permanent register (do=pv) is returned in the case of a buffer marked as invalid (vb=0). The entire behavior of the rollback-capable register is controlled by the control unit (the behavior of the control unit being specified by the truth table in FIG. 4).

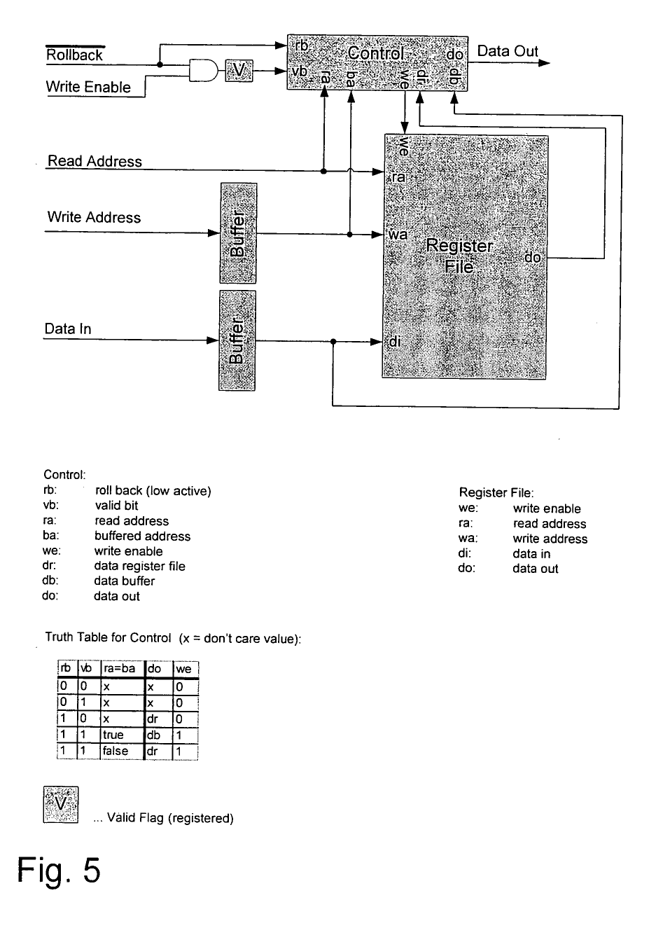

FIG. 5 shows how an entire register file can be equipped with rollback capability (the register file in FIG. 3 being a rollback-capable register file). A rollback-capable register file is made up of the register file itself, a data buffer, an address buffer, a valid bit and a control logic. New data are not written directly into the register file, but first into the data buffer (the associated address being written into the address buffer). If at the time of storing the data the rollback signal is inactive (rb=1; rb is low-active), then the buffer content is marked as valid using a valid bit (vb=1). If at the beginning of the next clock cycle the rollback signal is still inactive (that is, no rollback is to occur), then the content of the buffer is transferred to the register file (the addressing occurring via the address stored in the address buffer). If on the other hand the rollback signal is active (rb=0), no new value is written to the register file and the buffer contents are marked as invalid (vb=0) using the valid bit. Buffer contents marked as invalid are never transferred into the register file. In a read access, in the case of a buffer marked as valid (vb=1), a check is performed as to whether the address in the address buffer matches the address to be read (ra=ba). If this is the case, then the content of the data buffer is returned (do=db) since it corresponds to the most current valid value at this address (a valid value in the buffer being more current than the corresponding value in the register file). If the address to be read and the address in the address buffer do not match (ra not equal to ba), then there exists no more current version of this register content in the buffer than in the register file itself. In this case, the relevant value of the register file is returned (do=dr). In the case of a buffer content marked as invalid, the corresponding value from the register file is always supplied (do=dr). The entire behavior of the rollback-capable register file is controlled by the control unit (the behavior of the control unit being specified by the truth table in FIG. 5).

The diagram in Table 2 shows the function of the improved instruction retry mechanism (IIRM) with the aid of an example.

TABLE 2
Exemplary Sequence of the IIRM

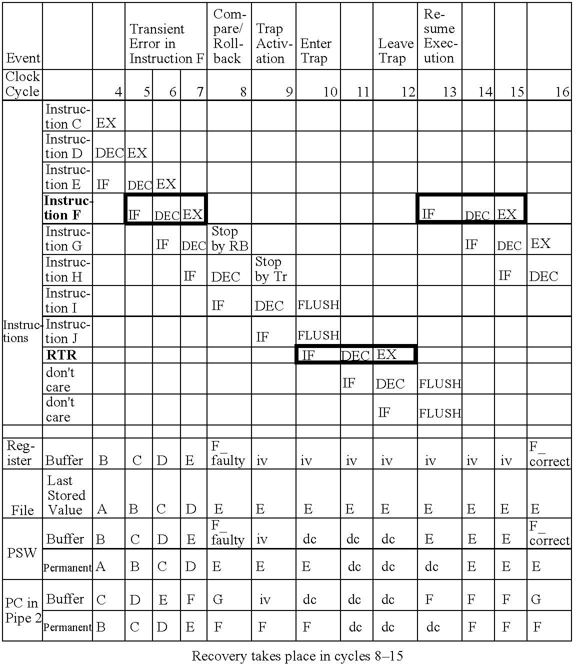

Legend:
IF Instruction Fetch
Dec Decode
EX Execute
RTR Return from Trap Routine
Stop by RB (Rollback) During rollback no new values are written to registers/buffers
Stop by Tr (Trap) If a synchronous trap is activated no new values are written to registers/buffers
Iv (invalidated) After rollback the buffer is invalidated
dc (don't care) We don't care how these registers are used while a trap is processed
PSW Program Status Word
PC in Pipe 2 Register that hold the address of the actual instruction in the EX stage

The upper section of Table 2 shows (under Instructions) in which pipeline stage a particular instruction is found during a particular clock cycle. The lower section of the diagram lists the contents of the rollback-capable register (buffer and permanent register) during the individual clock cycles. For the rollback-capable register file there is an indication for every clock cycle what value is contained in the buffer and what value was last entered into the register file itself. A value such as A or B means that it is a result of the instruction A or the instruction B. It is assumed that a transient error occurs at any stage of the instruction F (clock cycle 5-7). In clock cycle 8 at the latest, this error is detected by one of the comparators, the subsequent instruction (G) is prevented from writing its results, and the rollback is triggered. At the start of clock cycle 9, all registers of the EssentialRegisterSet are already rolled back (the buffer having been marked as invalid, which makes the values in the permanent registers into the most current valid values), and the InstructionRetryTrap is triggered. The triggered trap prevents instruction H from writing its results. The InstructionRetryTrap is an empty trap and is thus only made up of the “return from trap routine” (RTR) instruction. In clock cycle 12, the RTR instruction has already reached the execute stage, which results in a renewed fetching of the previously faulty instruction F in clock cycle 13. At the beginning of clock cycle 16, the instruction F was repeated entirely and it wrote its correct results.

External Outputs

The described recovery mechanism must ensure that transient errors within the dual core are prevented from advancing to the external components (cache, data storage unit, additional modules, . . . ). In the case of the BIRM, this condition is implicitly satisfied since the InstructionRetryTrap is already triggered in the same clock cycle if errors become visible in the output lines (lines 7 and 8 in FIG. 2). As was already mentioned under “Instruction Repetition”, the trap mechanism prevents any writing access to external components if a trap is triggered.

In contrast to BIRM, in the second version of the recovery mechanism (IIRM), an error is detected only when the faulty data have already been written. To prevent faulty data from entering external components, a buffer may be interconnected between the dual core and the I/O control unit of the system. New data are first written into the buffer and are thus delayed by one clock cycle until the check of the data has been concluded. Correct data are passed on to the I/O control unit. If on the other hand the data are classified as faulty, then the content of the buffer is marked as invalid using the rollback signal. Marking the buffer as invalid may be implemented in any manner desired (e.g. reset of the buffer register, deletion of the write enable bit in the control signals to the I/O control unit, . . . ).

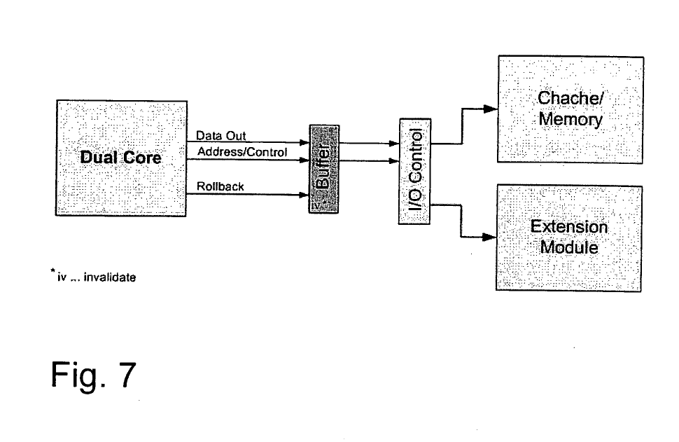

FIG. 7 shows the placement of the buffer between the dual core and the I/O control unit. In this example, the I/O control unit is connected to a memory including a cache and an arbitrary expansion module (e.g. D/A converter, network interface, . . . ).

Permanent Errors

In order to be able to distinguish permanent errors from transient errors, an error counter may be used. Most secure is the use of an independent component which ascertains the error frequency within a certain time interval by monitoring the two trap lines (InstructionRetryTrap and RegErrorTrap) used by the recovery mechanism or the rollback line. If the error frequency per unit of time exceeds a certain threshold value, the error may be regarded as permanent.

Bit Flips in the Register File

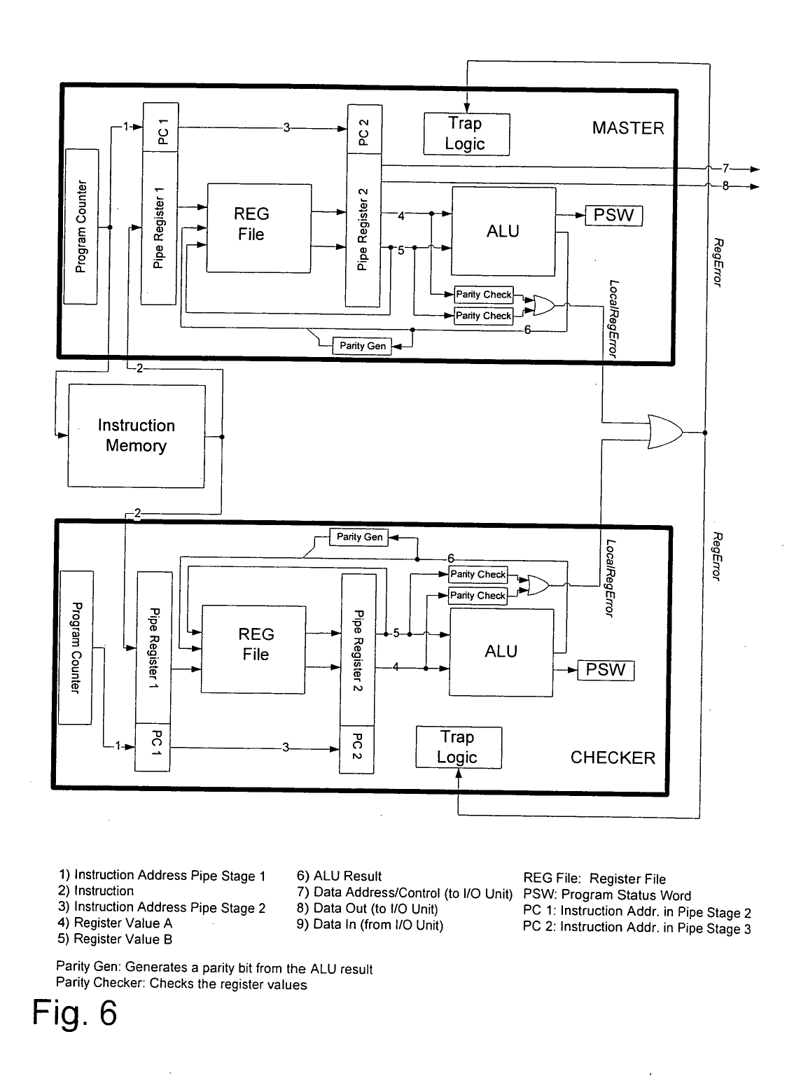

Not every transient error, of course, can be corrected by instruction repetition. Errors arising from bit flips in the register file are not corrected even by repeated readout. To be able to correct such errors, an additional mechanism was integrated, which detects register errors as such and reports them to the operating system. For this purpose, all data values in the register file are secured by parity bits (the parity bit being generated by a parity generator connected downstream of the ALU: FIG. 6). In every read access to the register file, the read-out value is subjected to a parity check. The outputs of all parity checkers of a CPU are combined with one another to form a signal called LocalRegError. The LocalRegError signals of both CPUs are in turn combined with one another to form the signal RegError. This signal signals that in at least one of the two CPUs a parity error was detected when reading out a register value. In this case, a trap routine called RegErrorTrap is triggered in both cores, which informs the operating system about the register error. The error information which is provided here to the operating system is precise since the return address of the trap routine stores precisely the address of the instruction which accessed the faulty register. This makes it possible for the operating system to react in a specific manner (repetition of the relevant task or call of a specific error handler). It is crucially important that both CPUs (even the error-free CPU) jump into the trap routine in order to maintain the synchronicity.

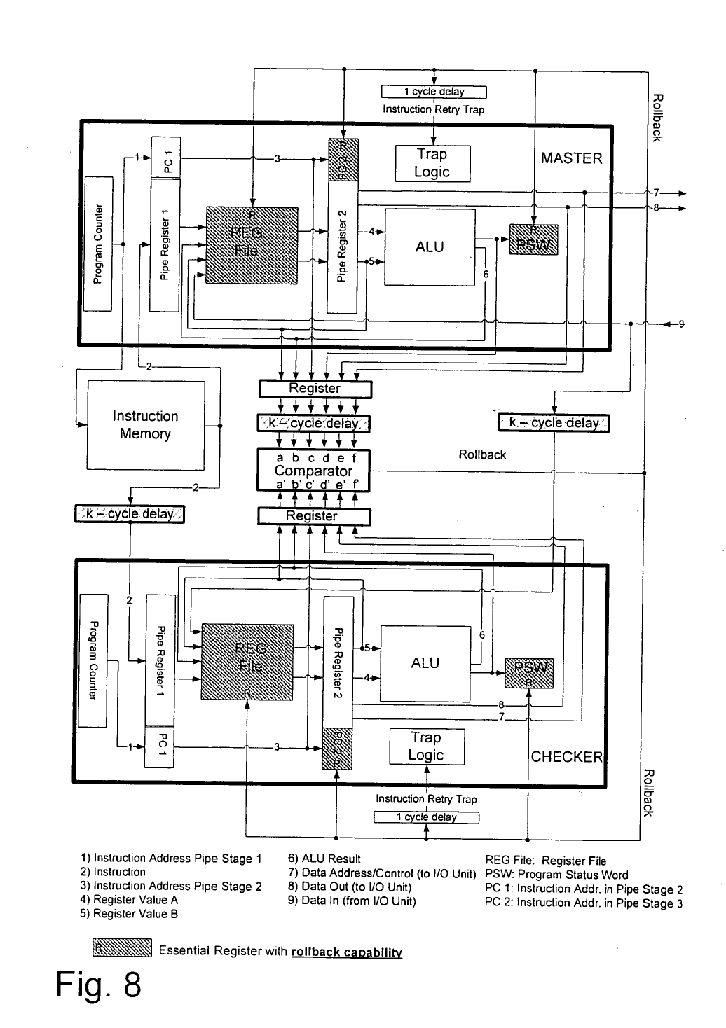

The described recovery mechanism is fundamentally based on error detection by comparison of the output signals of master and checker and on error correction by instruction repetition. Master and checker now work for example at a clock cycle offset, the checker always running behind the master by a defined time interval (k clock cycles, where k is a real number). The time interval may be made up of a defined number of full clock cycles or a defined number of half cycles. In order to allow for a comparison, the output signals of the master must be temporarily stored by appropriate delay components until the corresponding output signals of the checker are available. FIG. 8 shows the placement of the delay components (“k-delay”) in the described error-tolerant dual-core processor. The signals of the master to be compared are delayed by k clock cycles by the delay component “k-delay” before reaching the comparator. Since the checker is running behind the master, the checker must, of course, also receive its input signals in a delayed manner in relation to the master. Delay components likewise provide for delaying the instruction and the input data provided by the I/O unit. The signals to be compared are not conducted directly from the master or checker to the delay component (“k-delay”) or to the comparator, but are first temporarily stored in a register. As a result, a full clock cycle is available for comparing the signals and for triggering the instruction repetition, and the timing of the CPUs is not negatively affected by the comparator. The temporary storage in the register extends the error detection time by an additional clock cycle. The error detection time results from the clock cycle offset between the master and the checker and the additional clock cycle implied by the registers (error detection time=k+1).

Rollback of the Processor State

The rollback of the processor state occurs at the instruction level and is accomplished by a mechanism called “instruction retry mechanism” (IRM). The goal of the IRM is to roll the entire processor back into a state it was in prior to the occurrence of the error. For this purpose, the mechanism uses mainly the trap (exception) mechanism already present in conventional processors.

The trap (exception) mechanism for this purpose must satisfy the following requirements: As soon as a trap is triggered, any instruction present in the pipeline of the processor at this time will be prevented from changing the processor state.

In the subsequent clock cycle, the system jumps into a trap routine assigned to the trap. A trap routine may be terminated again by the instruction “return from trap routine” (RTR), which results in the execution being resumed again with the instruction that was present in the last pipeline stage at the time the trap was triggered.

Now, in order to repeat an instruction with the aid of the trap mechanism, an “empty” trap routine is called (an empty trap routine is defined as a routine made up exclusively of the instruction “return from trap routine”). Since it is an “empty” trap routine, it is again terminated immediately after being called. The pipeline is emptied and the execution is resumed again precisely with the instruction that was present in the last pipeline stage at the time the trap was triggered. This empty trap routine is called an InstructionRetryTrap.

The InstructionRetryTrap can bring about a valid processor state only if certain registers have a valid and consistent content. The set of these registers is called essential registers and includes all registers the content of which must be saved or retained in the event of a trap call. This includes above all the register file, the status register and, depending on the architecture, various control registers such as an exception vector table for example. The most important register of the essential registers is the register that stores the address of the instruction in the last pipeline stage since it is precisely this address to which the system must jump when terminating the trap. In FIG. 8, the essential registers are shown in an exemplary architecture (REG file: register file, PC 2: address of the instruction in the last pipe stage, PSW: status register). All registers that do not belong to the essential registers are called derivable registers since their contents can be derived with the aid of the InstructionRetryTrap (they are emptied first by the trap and filled again with valid values by the subsequent program execution).

To be able therefore to ensure a correct functioning of the InstructionRetryTrap, all errors in the essential registers must first be detected and corrected. The error detection is achieved by comparing the write accesses of the master of those of the checker to the essential registers (the comparison being performed by the comparator component). As already mentioned above, a time-offset dual core has an error detection time of k+1 clock cycles. Therefore, following a detected error, the essential registers have to be rolled back k+1 clock cycles in order to regain a valid state.

This is made possible by expanding the essential register to include roll back capability (see next section). As already mentioned, a valid state in the essential registers is a necessary and sufficient condition for being able to create a complete and valid processor state with the aid of the InstructionRetryTrap (the derivable registers thus do not have to be equipped with rollback capability).

Rollback of the Essential Registers

This section describes how an individual register or an entire register file may be equipped with rollback capability which allows it to roll the register or the register file back by a certain number of clock cycles.

Individual Register

This section shows how an individual register, which is written to in every cycle (e.g. pipe register, may be equipped with rollback capability. A rollback-capable individual register is made up of a control logic, a permanent register and one or multiple temporary buffers. In the process, the data to be stored first run through the temporary buffer before being taken over into the permanent register. In order to carry out a rollback, all buffer contents are marked as invalid. Buffer contents marked as invalid are never taken over into the permanent register. The number of the temporary buffers corresponds to the number of clock cycles by which the register is rolled back in a rollback. When reading out the register, one must take into account that it is always the most current valid value that must be returned. When no rollback has occurred, that is, when the buffers are marked as valid, the most current valid value is always located in the first buffer. Immediately following a rollback, the most current valid value is located in the permanent register.

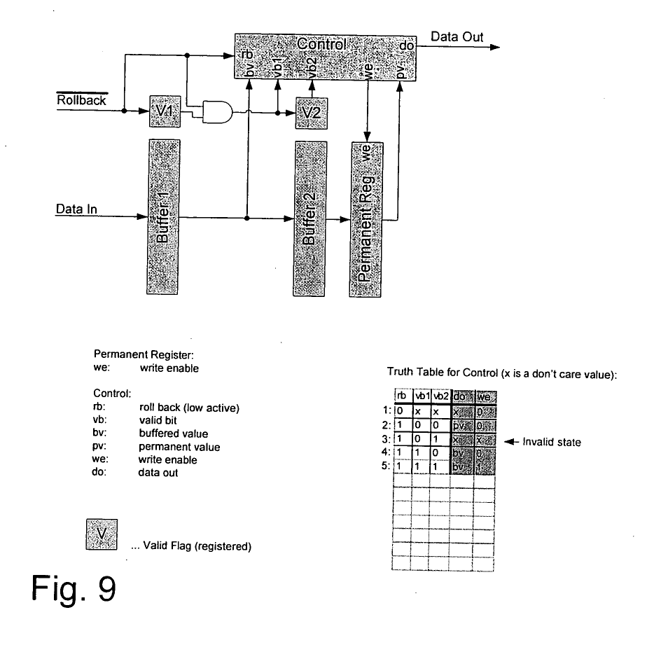

FIG. 9 outlines the example of a rollback-capable register that can be rolled back by 2 cycles, that is, which has 2 temporary buffers (“buffer 1” and “buffer 2”) and two associated valid bits (“V1” and “V2”). The permanent register, the temporary buffers and the valid bits are clocked, while the control logic is implemented as an asynchronous logic unit. With every clock cycle edge, the applied data are taken over into “buffer 1”, and the old content is shifted from “buffer 1” into “buffer 2”. In the case of an inactive rollback signal, at each clock cycle edge, the new value of the first valid bit (“V1”) is set to valid and the old value is shifted from “V1” to “V2”. The content of “buffer 2” is taken over into the permanent register only if the rollback signal is inactive and “V2” is set to valid. In order to carry out a rollback, the rollback signal is set to active, which results in both valid bits (“V1” and “V2”) being set to invalid at the next clock cycle edge and in the permanent register maintaining its current value. In the case of read accesses, the most current valid value is ascertained as follows: If “V1” is set to valid, then the content of “buffer 1” represents the most current valid value. If “V1” is set to invalid, then a rollback occurred in the last cycle, and the most current valid data must be read from the permanent register. The case where buffer 2 would contain the most current valid value can never occur since in a rollback “buffer 1” and “buffer 2” are always jointly marked as invalid and “buffer 1” is the first to be filled again with valid values (in a register that is written to in each clock cycle, “V1”=invalid and “V2”=valid can never occur).

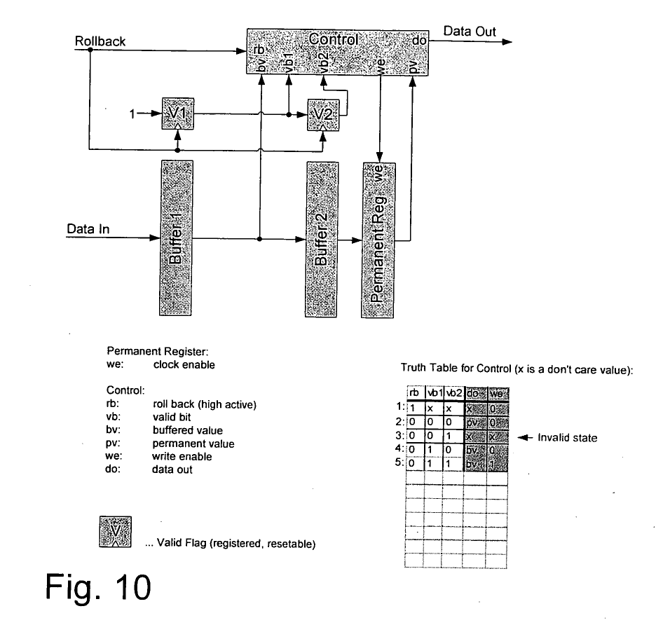

The entire behavior of the rollback-capable register is controlled by the control unit. The behavior of the control unit is specified by the truth table in FIGS. 9 and 10. In FIG. 9, the valid bit is reset by the AND gate and in FIG. 10 by reset:
1. If the rollback signal is active (that is, rb=0 since rollback is a low-active signal), no new value is ever taken over into the permanent register (we=0). Any value may be applied at the output.
2. If the rollback signal is inactive (rb=1) and both buffers are marked as invalid (vb1=0, vb2=0), no new value is taken over into the permanent register (we=0). The value of the permanent register (do=pv) must then be present at the output.
3. The state in which in the case of an inactive rollback signal (rb=1) the first buffer contains no valid value (vb1=0) whereas the second does (vb2=1) can never occur. Following a rollback, both valid bits are always set to 0. Subsequently, the first valid bit is always the first to be marked as valid (vb1=1). If later another rollback occurs, then both valid bits are again marked as invalid (vb1=0, vb2=0).
4. If in the case of an inactive rollback (rb=1), the first buffer is marked as valid (vb2=1) and the second buffer is marked as invalid (vb2=0), then no new value is taken over into the permanent register (we=0). The value of the first buffer is then applied at the output (do=by).
5. If in the case of an inactive rollback (rb=1), the first and second buffers are marked as valid (vb2=1, vb2=1), then the data of the second buffer are taken over into the permanent register (we=1). The value of the first buffer is then applied at the output (do=bv).
   Register File

This section shows how a register file, which in contrast to the previously described individual register is not necessarily written to in every clock cycle, can be equipped with rollback capability. A rollback-capable register file is made up of a control logic, the register file itself and one or several temporary buffers, each of which are able to store one data word and one register address. Together with the associated addresses, the data to be stored first run through the temporary buffers before being taken over into the register file. In order to carry out a rollback, all buffer contents are marked as invalid. Buffer contents marked as invalid are never taken over into the register file. The number of the temporary buffers corresponds to the number of clock cycles by which the register file is rolled back in a rollback. When reading out the register file, one must take into account that it is always the most current valid value that is read out. The latter is located in the first valid buffer that contains the desired address. If no valid temporary buffer contains the desired address or if all temporary buffers are marked as invalid, then the system always reads directly out of the register file.

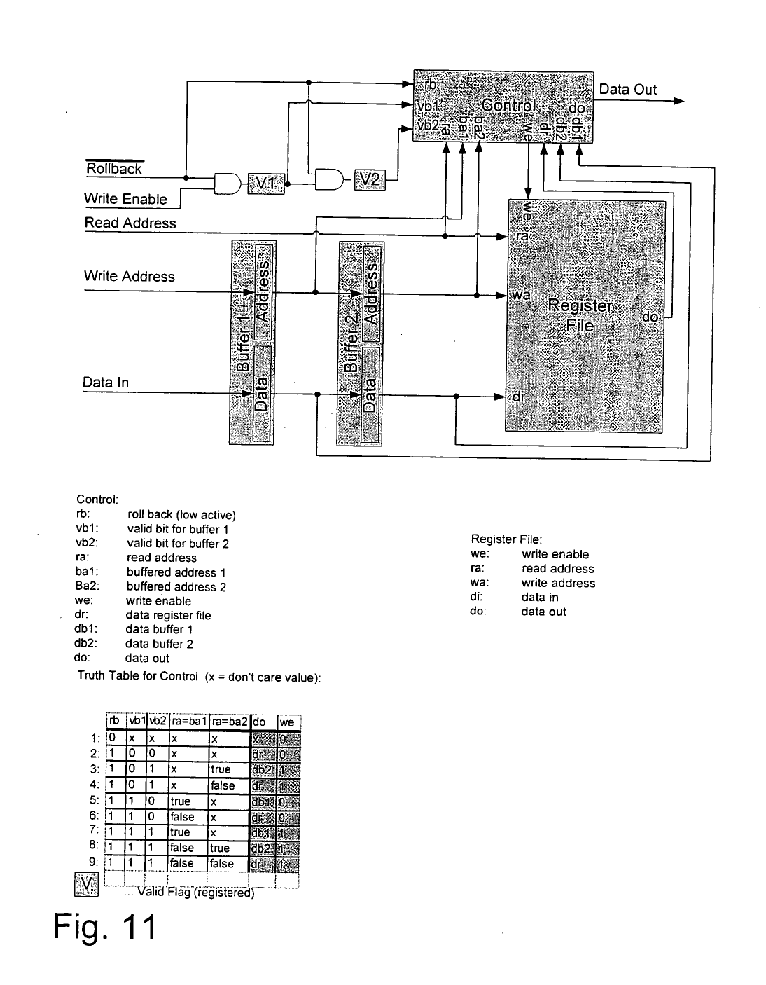

FIG. 11 outlines the example of a rollback-capable register file that can be rolled back by 2 cycles, that is, which has 2 temporary buffers (“buffer 1” and “buffer 2”) and two associated valid bits (“V1” and “V2”). The register file itself, the temporary buffers and the valid bits are clocked, while the control logic is implemented as an asynchronous logic unit. With every clock cycle edge, the applied data and the applied address are jointly taken over into “buffer 1”, and the old content of “buffer 1” is shifted into “buffer 2” (the old value at the same time being shifted from “V1” to “V2”). The new buffer content of “buffer 1” is marked as valid using valid bit “V1” if the write enable signal is applied and the rollback signal is inactive (that is, if the register file is indeed to be written to and no rollback occurs). The data of “buffer 2” are only transferred into the actual register file if the buffer content is marked as valid by “V2” and the rollback signal is inactive. In order to carry out a rollback, the rollback signal is set to active, which results in both valid bits (“V1” and “V2”) being set to invalid at the next clock cycle edge and writing to the register file being prevented already in the same clock cycle.

In the case of the rollback-capable register file, determining the most current valid value in reading accesses requires somewhat more effort than in the case of the previously described rollback-capable individual register and is therefore described in pseudo code:

IF “V1” = valid AND address in “buffer 1” = address to be read
THEN most current valid value in “buffer 1”
ELSEIF “V2” = valid AND address in “buffer 2” = address to be
read THEN most current valid value in “buffer 2”
ELSEIF most current valid value in the register file itself

The entire behavior of the rollback-capable register file is controlled by the control unit. The behavior of the control unit is specified by the truth table in FIG. 11:
1. If the rollback signal is active (that is, rb=0 since rollback is a low-active signal), no new value is ever taken over into the register file (we=0). The output may provide an arbitrary value.
2. If the rollback signal is inactive (rb=1) and both buffers are marked as invalid (vb1=0, vb2=0), no new value is taken over into the register file (we=0). The value read out from the register file must then be applied at the output (do=dr).
3. If the rollback signal is inactive (rb=1), the first buffer is marked as invalid (vb1=0) and the second buffer is marked as valid (vb2=1), and the address to be read corresponds to the address stored in the second buffer ((ra=ba2)=true), then the data content of the second buffer must be present at the output (do=db2). The content of the second buffer is written into the register file (we=1).
4. If the rollback signal is inactive (rb=1), the first buffer is marked as invalid (vb1=0) and the second buffer is marked as valid (vb2=1), and the address to be read does not correspond to the address stored in the second buffer ((ra=ba2)=false), then the value read out from the register file must be applied at the output (do=dr). The content of the second buffer is written into the register file (we=1).
5. If the rollback signal is inactive (rb=1), the first buffer is marked as valid (vb2=1) and the second buffer is marked as invalid (vb2=0), and the address to be read corresponds to the address stored in the first buffer ((ra=ba1)=true), then the data content of the first buffer must be applied at the output (do=db1). The register file is not written to (we=).
6. If the rollback signal is inactive (rb=1), the first buffer is marked as valid (vb2=1) and the second buffer is marked as invalid (vb2=0), and the address to be read does not correspond to the address stored in the first buffer ((ra=ba1)=false), then the value read out from the register file must be applied at the output (do=dr). The register file is not written to (we=0).
7. If the rollback signal is inactive (rb=1), both buffers are marked as valid (vb2=1, vb2=1) and the address to be read corresponds to the address stored in the first buffer ((ra=ba1)=true), then the data content of the first buffer must be applied at the output (do=db1). The content of the second buffer is written into the register file (we=1).
8. If the rollback signal is inactive (rb=1), both buffers are marked as valid (vb2=1, vb2=1), the address to be read does not correspond to the address stored in the first buffer ((ra=ba1)=false) and the address to be read corresponds to the address stored in the second buffer ((ra=ba2)=true), then the data content of the second buffer must be applied at the output (do=db2). The content of the second buffer is written to the register file (we=1).
9. If the rollback signal is inactive (rb=1), both buffers are marked as valid (vb2=1, vb2=1), the address to be read does not correspond to the address stored in the first buffer ((ra=ba1)=false) and the address to be read also does not correspond to the address stored in the second buffer ((ra=ba2)=false), then the value read out from the register file must be applied at the output (do=dr). The content of the second buffer is written to the register file (we=1).

The diagram in Table 3 shows the sequence of the instruction retry mechanism (IRM) with the aid of an example. For this purpose it is assumed that master and checker run at a clock cycle offset of one clock cycle, and that an error occurs during the processing of instruction number 50.

TABLE 3
Exemplary sequence of the instruction retry
mechanism IRM at a clock cycle offset

| Cycle | | IF | DE | EX | |
|---|---|---|---|---|---|
| 1 | Master | 52 | 51 | 50 | Master is executing |
| | Checker | 51 | 50 | 49 | instruction 50; Checker is |
| | | | | | executing instruction 49 |
| 2 | Master | 53 | 52 | 51 | Master has executed |
| | Checker | 52 | 51 | 50 | instruction 50; Checker is |
| | | | | | currently executing |
| | | | | | instruction 50; |
| 3 | Master | 54 | 53 | 52 | Checker has executed |
| | Checker | 53 | 52 | 51 | instruction 50; Results are |
| | | | | | compared; Error is |
| | | | | | detected; Rollback is |
| | | | | | triggered |
| 4 | Master | xxx | xxx | xxx | Essential Registers have |
| | Checker | xxx | xxx | xxx | been rolled back; The IRT |
| | | | | | (instruction Retry Trap) can |
| | | | | | be triggered now; |
| 5 | Master | RTR | flushed | flushed | The pipeline is flushed, and |
| | Checker | RTR | flushed | flushed | the RTR (Return from Trap |
| | | | | | Routine) Instruction is |
| | | | | | fetched |
| 6 | Master | any inst. | RTR | flushed | RTR propagates |
| | Checker | any inst. | RTR | flushed | |
| 7 | Master | any inst. | any inst. | RTR | RTR propagates |
| | Checker | any inst. | any inst. | RTR | |
| 8 | Master | 50 | flushed | flushed | RTR has been executed; |
| | Checker | 49 | flushed | flushed | Trap is left; Pipeline is |
| | | | | | flushed; Instruction 50 (49) |
| | | | | | is fetched by the Master |
| | | | | | (Checker) |
| 9 | Master | 51 | 50 | flushed | Execution continues |
| | Checker | 50 | 51 | flushed | |
| 10 | Master | 52 | 51 | 50 | Execution continues |
| | Checker | 51 | 50 | 49 | |
| 11 | Master | 53 | 52 | 51 | Master has executed |
| | Checker | 52 | 51 | 50 | instruction 50 |
| 12 | Master | 54 | 53 | 52 | Checker has executed |
| | Checker | 53 | 52 | 51 | instruction 50; Results are |
| | | | | | compared; Comparison is |
| | | | | | successful; Error has been |
| | | | | | recovered |

| | |
|---|---|
| Legend | |
| 4-7 | The shaded region shows the execution of the Instruction |
| | Retry Mechanism (IRM) |
| IF | Instruction Fetch State |
| DE | Decode Stage |
| EX | Execute Stage |
| RTR | Return from Trap Routine: Processor leaves the trap |
| | routines and continues the execution at the instruction |
| | where it has been interrupted before by the trap routine |
| xxx | Inconsistent State: Since only the Essential Registers are |
| | rolled back, while the other registers retain their |
| | values, the whole processor state becomes inconsistent. |

In the first observed clock cycle, the master is in the process of executing instruction 50, while the checker executes instruction 49. Instruction 50 can only be checked two clock cycles later (clock cycle 3), when both CPUs have already executed this instruction. In this clock cycle, an error is detected and the rollback is triggered for the essential registers. In the subsequent clock cycle (clock cycle 4), the essential registers have already been rolled back by two clock cycles (the essential registers being now again in the same state they occupied in clock cycle 1). Since until now only the essential registers have been rolled back and the remaining registers of the processor have retained their old value, the processor is in an inconsistent state. Nevertheless, the condition for the correct triggering of a trap is satisfied (the essential registers having correct and consistent values). In the same clock cycle, the Instruction Retry Trap (IRT) is now triggered. The InstructionRetryTrap is made up of a single instruction, the “Return From Trap Routine (RTR)” instruction. In clock cycle number 5, the RTR instruction is fetched. In clock cycle 7, the RTR instruction has reached the execute stage of the processor (in both CPUs). As a result of executing the RTR instruction, the pipeline of both CPUs is flushed and in both CPUs the instruction address is fetched, which at the time of triggering the InstructionRetryTrap (IRT) was located in the “PC2” register (FIG. 8) of the respective CPU (the return address for interrupts and traps being stored in the “PC2” register). Thus, the execution is resumed at address 50 and 49 in the master and checker respectively. At the beginning of clock cycle 12, both CPUs have completely repeated the previously faulty instruction, and the results have been checked successfully.

Bit Flips in the Register File

A bit flip is defined as a reversal of the logical value of a bit in a register caused by an interference.

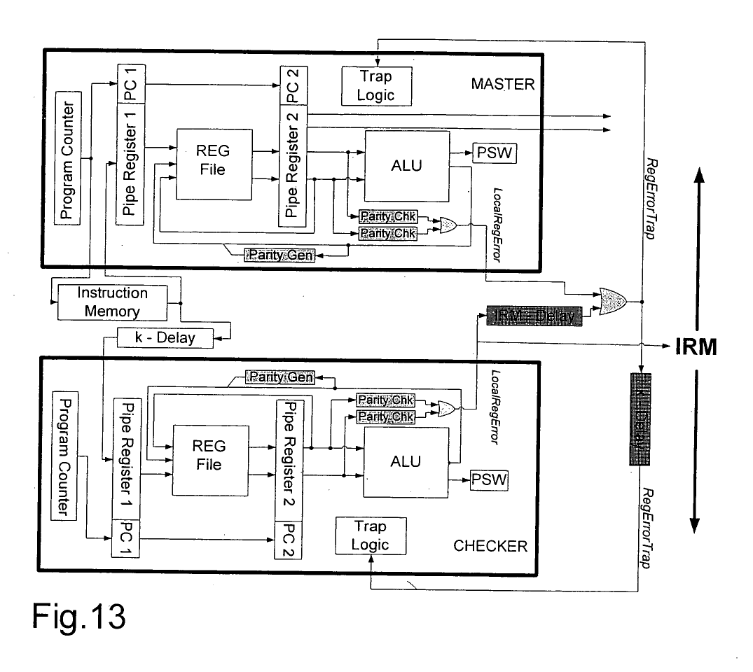

Bit flips in the register file generally cannot be corrected by rolling back the processor by a constant number of clock cycles t since they may affect registers that were written to most recently at a time going back further than t clock cycles. To be able to correct such errors, an additional mechanism was integrated, which detects register errors as such and reports them to the operating system. For this purpose, the individual registers are secured by parity bits (FIG. 13). In every read access to the register file, the read-out value is subjected to a parity check. Register errors are not corrected in hardware, but are reported to the operating system by a trap (RegErrorTrap). From the return address stored in the trap, the operating system knows precisely which instruction accessed the faulty register value. This makes it possible for the operating system to react in a specific manner (repetition of the relevant task or call of a specific error handler).

In order to maintain the synchronicity of the two CPUs, the RegErrorTrap (RET) must be triggered in both CPUs at precisely the same instruction. In the case of a dual core working at a clock cycle offset this means that the RET must also be triggered in an offset manner. In order to describe the offset triggering of the trap, timing diagrams were enclosed, which assume a clock cycle offset of k=1 and which show with reference to an example how the master or the checker react to bit flips in the register file. For this purpose it is assumed that in each case the instruction at address 50 reads out a faulty register content.

RET1, RET2, RET3, RET4 etc. refer to the first, second, third, fourth etc. instruction of the RegErrorTrap. What this trap routine does precisely (task repetition, call of an exception handler, . . . ) and how many instructions it comprises is left to the programmers of the operating system.

If a parity error occurs in the master (at instruction 50 in the example described), then the master enters into the RegErrorTrap in the next clock cycle. The “k-delay” component (see block diagram in FIG. 13) ensures that the checker triggers its RegErrorTrap only k clock cycles later (k=1), when it itself has reached instruction 50 (see flow chart in Table 4).

TABLE 4
Exemplary sequence for triggering the RegErrorTrap RET

| | | | |
|---|---|---|---|
| Cycle | IF | DE | EX |

Master detects parity error

| | | | | | |
|---|---|---|---|---|---|
| 1 | Master | 52 | 51 | 50 | Register parity error in instruction |
| | Checker | 51 | 50 | 49 | 50 detected by the master; |
| | | | | | Master's RET is triggered |
| 2 | Master | RET1 | flushed | flushed | Master enters RegisterErrorTrap |
| | Checker | 52 | 51 | 50 | (RET); Checkers RET is |
| | | | | | triggered by the “k-Delay” |
| | | | | | Component |
| 3 | Master | RET2 | RET1 | flushed | Checker enters |
| | Checker | RET1 | flushed | flushed | ReigsterErrorTrap (RET) |

Checker detects parity error

| | | | | | |
|---|---|---|---|---|---|
| 1 | Master | 53 | 52 | 51 | Register parity error in |
| | Checker | 52 | 51 | 50 | instruction 50 detected by the |
| | | | | | checker; Rollerback (IRM) is |
| | | | | | triggered |
| 2 | Master | xxx | xxx | xxx | Essential Registers have |
| | Checker | xxx | xxx | xxx | been rolled back; The IRT |
| | | | | | (Instruction Retry Trap) can |
| | | | | | be triggered now; |
| 3 | Master | RTR | flushed | flushed | The pipeline is flushed, and |
| | Checker | RTR | flushed | flushed | the RTR (Return from Trap |
| | | | | | Routine) Instruction is fetched |
| 4 | Master | any inst. | RTR | flushed | RTR propagates |
| | Checker | any inst. | RTR | flushed | |
| 5 | Master | any inst. | any inst. | RTR | RTR propagates |
| | Checker | any inst. | any inst. | RTR | |
| 6 | Master | 49 | flushed | flushed | After the InstructionRetryTrap |
| | Checker | 48 | flushed | flushed | is left, the execution is |
| | | | | | continued at instruction 49 at |
| | | | | | the master and at instruction |
| | | | | | 48 at the slave |
| 7 | Master | 50 | 49 | flushed | normal execution |
| | Checker | 49 | 48 | flushed | |
| 8 | Master | 51 | 50 | 49 | normal execution |
| | Checker | 50 | 49 | 48 | |
| 9 | Master | 52 | 51 | 50 | Master has instruction 50 in |
| | Checker | 51 | 50 | 49 | the execute stage; Master's |
| | | | | | RET is triggered by the “IRM- |
| | | | | | Delay” component |
| 10 | Master | RET1 | flushed | flushed | Master enters |
| | Checker | 52 | 51 | 50 | RegisterErrorTrap (RET); |
| | | | | | Checker's RET is triggered by |
| | | | | | the “k-Delay” Component |
| 11 | Master | RET2 | RET1 | flushed | Checker enters |
| | Checker | RET1 | flushed | flushed | RegisterErrorTrap (RET) |

| | |
|---|---|
| Legend: | |
| 2-5 | The shaded region shows the execution of the instruction |
| | Retry Mechanism (IRM) |
| RTR | Return from Trap Routine: Processor leaves the trap |
| | routine and continues the execution at the instruction |
| | where it has been interrupted before by the trap routine |
| RET | Register Error Trap: A parity error in the Register File |
| | is signaled to the operating system |
| xxx | Inconsistent State: Since only the Essential Registers |
| | are rolled back, while the other registers retain |
| | their values, the whole processor state becomes inconsistent. |

If the checker discovers a parity error (at instruction 50 in the example described), then first the described mechanism for instruction repetition IRM is triggered (see flow chart in Table 4). At the beginning of clock cycle 6, this again produced a state in which the master fetched the instruction 49 and the checker fetched the instruction 48 (in a dual core operating at a clock cycle offset of k=1, IRM always rolls both CPUs back by 2 instructions).

3 clock cycles later (at the beginning of clock cycle number 9), instruction 50 is in the execute stage of the master. From this state, the “IRM-delay” component (see block diagram in FIG. 13) triggers the same mechanism that is also responsible for parity errors in the master. In clock cycle 11, the master enters the RegErrorTrap and the checker, delayed by the k-cycle delay component, follows one clock cycle later.

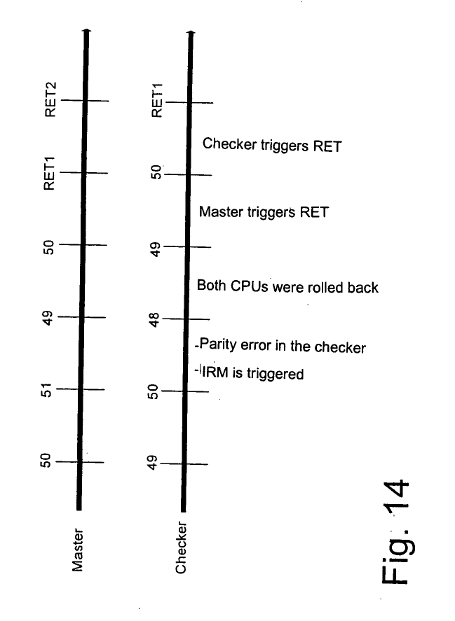

FIG. 14 finally shows the triggering of the RET for parity errors in the checker once more as an instruction diagram.

| | |
|---|---|
| IRM—Instruction Retry | The described recovery |
| Mechanism | mechanism for producing a |
| | valid processor state is made |
| | up of 2 phases: |
| | rollback of the essential registers |
| | triggering the InstructionRetryTrap |
| | (IRT) |
| | Is triggered by the rollback |
| | signal (Error! Reference |
| | source not found.); |
| | Parity error in the register |
| | file are not corrected by the |
| | IRM, but are reported to the |
| | operating system by RET |
| IRT—InstructionRetryTrap | An “empty” trap routine that |
| | is made up of a single |
| | instruction: the RTR |
| | instruction |
| RTR—Return from Trap Routine | Instruction for terminating a |
| | trap; must already be present |
| | in the instruction set of the |
| | processor |
| RET—RegErrorTrap | A trap that informs the |
| | operating system about parity |
| | errors in the register file; |
| | In this case, the recover is |
| | taken over by the operating |
| | system |

What is claimed is:

1. A device for correcting errors in a processor, comprising:
two execution units;
registers, in which at least one of instructions and associated information is storable, the at least one of the instructions and the associated information being processed redundantly in both of the execution units, wherein the registers of the processor are divided into first registers and second registers, the first registers being arranged so that a specifiable state of the processor and contents of the second registers are derivable therefrom;
a comparison arrangement to detect at least one of a deviation and an error by comparing the at least one of the instructions and the associated information; and
a rollback arrangement which is arranged so that at least of an instruction and associated information in the first registers are rolled back and are at least one of executed anew and restored.

2. The device of claim 1, wherein the rollback arrangement is arranged so that it is one of assigned only to and contained in the first registers.

3. The device of claim 1, wherein the rollback arrangement is arranged so that at least one instruction and the associated information is rolled back only in the first registers.

4. The device of claim 1, wherein the comparison arrangement is provided in front of the first registers.

5. The device of claim 1, wherein the comparison arrangement is provided in front of the outputs.

6. The device of claim 1, wherein at least one buffer component is assigned to each of the first registers.

7. The device of claim 1, wherein the registers are organized in at least one register file, and wherein at least one buffer component includes one buffer memory for addresses and one buffer memory for data being assigned to the at least one register file.

8. The device of claim 6, further comprising:
an arrangement to indicate a validity of the buffer component or buffer memory.

9. The device of claim 1, wherein the two execution units work in parallel without clock cycle offset.

10. The device of claim 1, wherein the two execution units work at a clock cycle offset.

11. The device of claim 1, wherein at least all of the first registers exist in duplicate and are in each case assigned once to one of the execution units.

12. A processor comprising:
a device for correcting errors in a processor, including:
two execution units;
registers, in which at least one of instructions and associated information is storable, the at least one of the instructions and the associated information being processed redundantly in both of the execution units, wherein the registers of the processor are divided into first registers and second registers, the first registers being arranged so that a specifiable state of the processor and contents of the second registers are derivable therefrom;
a comparison arrangement to detect at least one of a deviation and an error by comparing the at least one of the instructions and the associated information; and
a rollback arrangement which is arranged so that at least of an instruction and associated information in the first registers are rolled back and are at least one of executed anew and restored.

13. A method for correcting errors in a processor having two execution units, at least one of instructions and associated information being storable in registers, the method comprising:
processing the instructions redundantly in both of the execution units;
detecting at least one of a deviation and an error by comparing the at least one of the instructions and the associated information, wherein the registers of the processor are divided into first registers and second registers, a specifiable state of the processor and contents of the second registers being derivable from the first registers; and
at least one of an instruction and associated information in the first registers being rolled back and at least one of executed anew and restored when an error occurs.

14. The method of claim 13, wherein a validity of at least one of the instructions and the associated information about a validity identifier is at least one of specifiable and ascertainable, the validity identifier being reset via a reset signal.

15. The method of claim 13, wherein a validity of at least one of the instructions and the associated information about a validity identifier is at least one of specifiable and ascertainable, the validity identifier being reset via a logical gate signal.

16. The method of claim 1, wherein the rollback is divided into two phases, and at least one of the instructions and the associated information of the first registers are rolled back, and then the contents of the second registers are derived.

17. The method of claim 1, wherein the contents of the second registers are derived by a trap/exception mechanism.

18. The method of claim 13, wherein in addition to the rollback at least one bit flip of a first register of an execution unit is corrected in that the bit flip is indicated in both of the execution units.

19. The method of claim 18, wherein the bit flip is indicated simultaneously in both of the execution units if both of the execution units work without clock cycle offset.

20. The method of claim 18, wherein the bit flip is indicated in both execution units in an offset manner in accordance with a specifiable clock cycle offset if both of the execution units work at this clock cycle offset.
